(19) United States
(12) Patent Application Publication
(10) Pub. No.: US 2008/0138508 A1
(43) Pub. Date: Jun. 12, 2008

(54) Substrate Processing Method and Substrate Processing Apparatus

(76) Inventors: Daisuke Takagi, Tokyo (JP); Xinming Wang, Tokyo (JP); Akira Owatari, Tokyo (JP); Masanori Ishizaka, Tokyo (JP); Akira Fukunaga, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/885,870

(22) PCT Filed: Mar. 6, 2006
(86) PCT No.: PCT/JP2006/304815

§ 371 Date: Sep. 7, 2007

(30) Foreign Application Priority Data
Mar. 7, 2005 (JP) 2005-062831

(51) Int. Cl. B05D 5/12; B05C 3/02; C09D 5/00

(52) U.S. Cl. 427/123; 118/73; 106/1.22; 106/1.24

(57) ABSTRACT

A substrate processing method is useful for forming, by electroless plating, a protective film, such as a magnetic film, which covers exposed surfaces of embedded interconnects composed of an interconnect material, such as copper or silver, embedded in fine interconnect recesses provided in a surface of a substrate. The substrate processing method includes bringing a surface of a substrate into contact with a processing solution whose temperature is adjusted to not more than 15° C., thereby activating the surface, and bringing the activated surface of the substrate into contact with a plating solution, thereby forming a metal film on the surface.

### TECHNICAL FIELD

The present invention relates to a substrate processing method and a substrate processing apparatus, and more particularly to a substrate processing method and a substrate processing apparatus which are useful for forming, by electroless plating, a conductive film having the function of preventing thermal diffusion of an interconnect material into an interlevel dielectric film or the function of improving the adhesion between interconnects and an interlevel dielectric film, or forming a protective film, such as a magnetic film, which covers interconnects, on bottom surfaces, side surfaces or exposed surfaces of embedded interconnects composed of an interconnect material, such as copper or silver, embedded in fine interconnect recesses provided in a surface of a substrate, such as a semiconductor wafer.

### BACKGROUND ART

As an interconnect formation process for semiconductor devices, there is getting employed a process (so-called damascene process) in which metal (conductive material) is embedded in interconnect trenches and contact holes. This process includes embedding aluminum or, recently, metal such as copper or silver in interconnect recesses, such as trenches and contact holes, which have previously been formed in an interlevel dielectric film, and then removing excessive metal by chemical mechanical polishing (CMP) so as to flatten a surface of the substrate.

Conventionally, in a case of such interconnects, for example, copper interconnects, which use copper as an interconnect material, there has been employed a method in which a barrier layer is formed on bottom surfaces and side surfaces of the interconnects to prevent thermal diffusion of the interconnects (copper) into an interlevel dielectric film and to improve electromigration resistance of the interconnects so as to improve the reliability, or a method in which an anti-oxidizing film is formed to prevent oxidation of the interconnects (copper) under an oxidizing atmosphere so as to produce a semiconductor device having a multi-level interconnect structure in which insulating films (oxide films) are subsequently laminated. Generally, metal such as tantalum, titanium, or tungsten, or nitride thereof has heretofore been used as this type of barrier layer. Nitride of silicon has generally been used as an anti-oxidizing film.

Recently, as an alternative of the above methods, there has been studied a method in which bottom surfaces and side surfaces or exposed surfaces of embedded interconnects are selectively covered with a protective film made of a cobalt alloy, a nickel alloy, or the like, to prevent thermal diffusion, electromigration, and oxidation of the interconnects.

FIGS. 1A through 1D illustrate, in a sequence of process steps, an example of forming copper interconnects in a semiconductor device. First, as shown in FIG. 1A, an insulating film (interlevel dielectric film) 2, such as an oxide film of SiO₂ or a film of low-k material, is deposited on a conductive layer 1a formed on a semiconductor base 1 having formed semiconductor devices. Contact holes 3 and trenches 4 as fine interconnect recesses are formed in the insulating film 2 by performing a lithography/etching technique or the like. Thereafter, a barrier layer 5 of TaN or the like is formed on the insulating film 2, and a seed layer 6 as a feeding layer for electroplating is formed on the barrier layer 5 by sputtering or the like.

Then, as shown in FIG. 1B, copper plating is performed onto a surface of a substrate W to fill the contact holes 3 and the trenches 4 with copper and, at the same time, deposit a copper film 7 on the insulating film 2. Thereafter, the barrier layer 5, the seed layer 6 and the copper film 7 on the insulating film 2 are removed by chemical mechanical polishing (CMP) or the like so as to leave copper filled in the contact holes 3 and the trenches 4 and have a surface of the insulating film 2 lie substantially on the same plane as this copper. Interconnects (copper interconnects) 8 composed of the seed layer 6 and the copper film 7 are thus formed in the insulating film 2, as shown in FIG. 1C.

Then, as shown in FIG. 1D, electroless plating is performed onto a surface of the substrate W to selectively form a protective film (cap material) 9 of, e.g., a CoWP alloy on surfaces of interconnects 8, thereby covering and protecting the surfaces of the interconnects 8 with the protective film 9.

There will be described a process of forming a protective film (cap material) 9 of such a CoWP alloy film selectively on surfaces of interconnects 8 by using a conventional electroless plating method. First, the substrate W such as a semiconductor wafer, which has been carried out a CMP process, is immersed, for example, in dilute sulfuric acid having an ordinary temperature for about one minute to remove impurities such as a metal oxide film on surfaces of interconnects 8 and CMP residues, such as of copper, remaining on a surface of an insulating film 2. After the surface of the substrate W is cleaned (rinsed) with a cleaning liquid such as pure water, the substrate W is immersed, for example, in a PdSO₄/H₂SO₄ mixed solution for about one minute to adhere Pd as a catalyst to the surfaces of the interconnects 8 so as to activate exposed surfaces of the interconnects 8.

After the surface of the substrate W is cleaned (rinsed) with pure water or the like, the substrate W is immersed, for example, in a CoWP plating solution at the solution temperature of 80° C. for about 120 seconds to carry out electroless plating (electroless COWP cap plating) selectively on surfaces of the activated interconnects 8. Thereafter, the surface of the substrate W is cleaned with a cleaning liquid such as pure water. Thus, a protective film 9 made of a COWP alloy film is formed selectively on the exposed surfaces of interconnects 8 so as to protect interconnects 8.

With regard to nonvolatile magnetic memories, current density in copper interconnects increases as memory cells become denser and the design rule becomes smaller, which can cause the problem of electromigration. Further, as memory cells become smaller, adjacent cells become closer and a writing current in memory cells increases, whereby crosstalk is more likely to occur. Prevention of crosstalk is therefore a significant problem. A yoke structure, comprising copper interconnects and a magnetic film of cobalt alloy, nickel alloy, or the like, encircling the interconnects, is considered to be effective for solving the problem. Such a magnetic film can be produced by, for example, electroless plating.

### DISCLOSURE OF INVENTION

When forming a protective film (cap material) of a COWP alloy by common electroless plating, surfaces of interconnects are subjected to an activation processing, such as an oxide film removal processing to remove an oxide film or a catalyst application processing to apply a catalyst of a noble metal, such as Pd, to the surfaces, as descried above. The catalyst application processing generally entails corrosion of a base material, which can lower the reliability of the interconnects. The above-described processing for removal of CMP residues, such as copper, remaining on an insulating film, to prevent a protective film from being formed on the insulating film, is generally carried out by using an inorganic acid, such as HF, H₂SO₄ or HCl, or an organic acid, such as oxalic acid or citric acid, or a mixture thereof. When such a processing solution contains a large amount of dissolved oxygen, a surface of a substrate being processed is likely to be oxidized, and the surface oxidation may adversely affect the electric properties of the processed interconnects.

The present invention has been made in view of the above situation. It is therefore an object of the present invention to provide a substrate processing method and a substrate processing apparatus which, by carrying out an activation processing, such as a catalyst application processing, with a processing solution optimized for a base material, can efficiently form a high-quality metal film (protective film) on surfaces of interconnects without deteriorating the electric properties of the interconnects.

In order to achieve the object, the present invention provides a substrate processing method comprising: bringing a surface of a substrate into contact with a processing solution whose temperature is adjusted to not more than 15° C., thereby activating the surface; and bringing the activated surface of the substrate into contact with a plating solution, thereby forming a metal film on the surface.

By carrying out an activation processing of a surface of a substrate while controlling the rate of diffusion of a material with a processing solution whose temperature is adjusted to not more than 15° C., corrosion of a base material upon the activation processing can be minimized. Further, by adjusting the temperature of the processing solution to not more than 15° C. to control the rate of diffusion of a material so that a reaction changes from reaction-controlled to diffusion-controlled, it becomes possible to carry out an activation processing of the surface of an interconnect pattern with a variation of pattern density while reducing the pattern-dependency of processing.

The temperature of the processing solution is preferably 4 to 15° C., more preferably 6 to 10° C.

Preferably, the surface of the substrate is brought into contact with the processing solution while cooling the substrate to not more than 15° C.

By bringing a surface of a substrate into contact with a processing solution, whose temperature is pre-adjusted to not more than 15° C., while cooling the substrate to not more than 15° C., a rise in the temperature of the processing solution upon its contact with the substrate can be prevented.

The substrate may have embedded interconnects composed of an interconnect metal embedded in interconnect recesses, and surfaces of the embedded interconnects are activated and the metal film is formed selectively on the activated surfaces.

According to this embodiment, a high-quality metal film (protective film) can be efficiently formed on the surfaces of embedded interconnects to protect the interconnects without deteriorating the electric properties of the interconnects.

Alternatively, the substrate may have interconnect recesses for filling them with an interconnect metal to form embedded interconnects, and the surfaces of the interconnect recesses are activated and the metal film is formed on the activated surfaces.

Preferably, the processing solution is a catalytic processing solution containing a catalyst metal salt in an amount of 0.005 g/L to 10 g/L.

The catalyst metal of the catalyst metal salt is, for example, at least one of Pd. Pt, Ru, Co, Ni, Au and Ag.

Among a variety of usable catalyst metals, such as Pd, Pt, and Ag, Pd is preferably used from the viewpoints of reaction rate, easy control of reaction, etc.

Preferably, the pH of the processing solution is 0 to 6, and is adjusted within the range of −0.2 to +0.2 around a target value.

Preferably, the surface of the substrate is kept in contact with the processing solution for not less than 15 seconds to activate the surface.

By keeping the surface of the substrate in contact with the processing solution for not less than 15 seconds, an insufficient surface activation processing due to a decrease in the activation processing rate can be prevented. In the case of activation processing for the surfaces of interconnects, it is preferred to carry out the activation processing in such a manner that the processing will not cause a rise of 5% or more in the resistance of the interconnects.

Methods for bringing a surface of a substrate into contact with a processing solution may include (1) a method in which a substrate is immersed in a processing solution held in a processing tank, (2) a method in which a pressurized processing solution is sprayed from a spray nozzle toward a substrate while rotating the substrate, (3) a processing solution is jetted from a nozzle toward a rotating substrate which is held with its front surface (surface to be processed) facing upwardly, (4) a method in which a roll of a porous material is brought into contact with a surface of a substrate while rotating the substrate and wetting the surface of the substrate with a processing solution by, for example, supplying the processing solution from a nozzle disposed above the substrate or allowing the processing solution to ooze from the interior of the porous roll, and (5) a method in which a substrate is immersed in a flowing processing solution held in a processing tank.

An amount of dissolved oxygen in the processing solution is preferably not more than 3 ppm.

This can prevent oxidation of the surface of the substrate by oxygen contained in the processing solution, thus preventing adverse effects of surface oxidation on the electric properties of interconnects after the activation processing. The processing solution remaining on the surface of the substrate is generally rinsed with a rinsing liquid, such as pure water. It is preferred to use as the rinsing liquid pure water or the like having a dissolved oxygen content of not more than 3 ppm.

The present invention also provides a processing solution for contact with a surface of a substrate to activate the surface, comprising a catalyst metal salt and a pH regulator, the temperature of the solution being adjusted to not more than 15° C.

The pH regulator may be an acid selected from hydrochloric acid, sulfuric acid, nitric acid, citric acid, oxalic acid, formic acid, acetic acid, maleic acid, malic acid, adipic acid, pimelic acid, glutaric acid, succinic acid, fumaric acid and phthalic acid, or a base selected from aqueous ammonium solution, KOH, tetramethylammonium hydride and tetraethylammonium hydride.

The present invention also provides a substrate processing apparatus comprising: a pre-processing unit for bringing a processing solution whose temperature is adjusted to not more than 15° C. into contact with a surface of a substrate, thereby activating the surface; an electroless plating unit for carrying out plating of the activated surface of the substrate to form a metal film; and a unit for cleaning and drying the substrate after the plating.

In a preferred aspect of the present invention, the pre-processing unit includes a substrate holder, capable of being cooled to a temperature of not more than 10° C., for holding and cooling the substrate.

By carrying out an activation processing of a substrate surface while controlling the rate of diffusion of a material with the use of a processing solution whose temperature is adjusted to not more than 15° C., and then forming a metal film on the substrate surface, according to the present invention, it becomes possible to efficiently form a high-quality metal film (protective film), e.g., on surfaces of interconnects to protect the interconnects without deteriorating the electric properties of the interconnects.

### BRIEF DESCRIPTION OF DRAWINGS

FIGS. 1A through 1D are diagrams illustrating, in a sequence of process steps, an example for forming copper interconnects in a semiconductor device;

FIG. 2 is a layout plan view of a substrate processing apparatus according to an embodiment of the present invention;

FIG. 3 is a front view of a pre-processing unit omitting an outer tank at the time of substrate delivery;

FIG. 4 is a front view of the pre-processing unit omitting the outer tank at the time of processing with a processing solution;

FIG. 5 is a front view of the pre-processing unit omitting the outer tank at the time of rinsing;

FIG. 6 is a cross-sectional view showing a processing head of the pre-processing unit at the time of substrate delivery;

FIG. 7 is an enlarged view of a portion A of FIG. 6;

FIG. 8 is a view of the pre-processing unit when the substrate is fixed, which corresponds to FIG. 7;

FIG. 9 is a system diagram of the pre-processing unit;

FIG. 10 is a cross-sectional view showing a substrate head of an electroless plating unit when a substrate is delivered;

FIG. 11 is an enlarged view of a portion B of FIG. 10;

FIG. 12 is a view of the substrate head of the electroless plating unit when the substrate is fixed, which corresponds to FIG. 11;

FIG. 13 is a view of the substrate head of the electroless plating unit at the time of plating, which corresponds to FIG. 11;

FIG. 14 is a front view showing, in a partially cutaway manner, a plating tank of the electroless plating unit when a plating tank cover is closed;

FIG. 15 is a cross-sectional view showing a cleaning tank of the electroless plating unit;

FIG. 16 is a system diagram of the electroless plating unit;

FIG. 17 is a plan view showing a post-processing unit;

FIG. 18 is a vertical cross-sectional view showing a drying unit;

FIG. 19 is a graph showing the rate of resistance change in Example and Comparative Example.

### BEST MODE FOR CARRYING OUT THE INVENTION

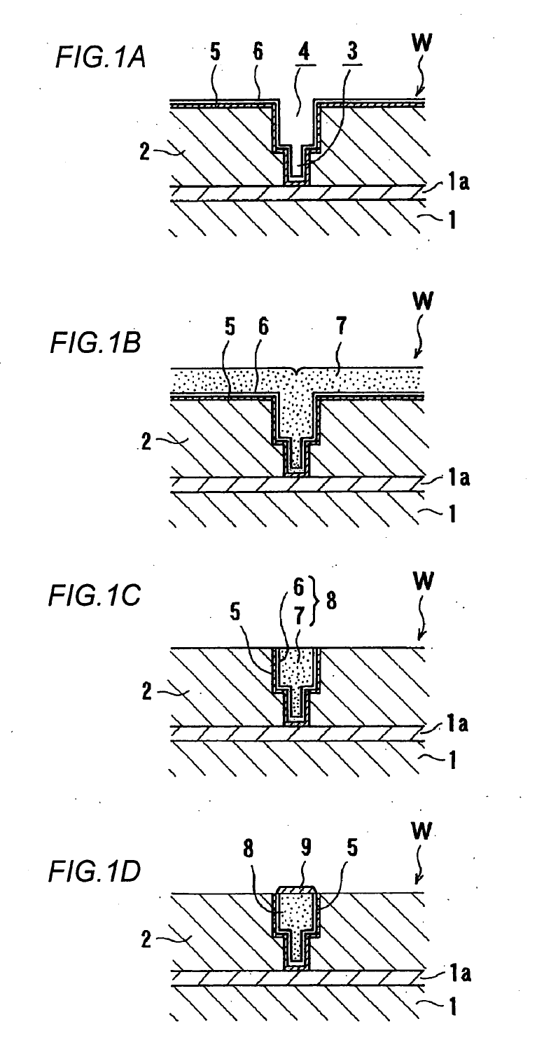

Preferred embodiments of the present invention will now be described with reference to the drawings. The following embodiments illustrate the case of forming a protective film (cap material) 9 of a COWP alloy selectively on exposed surfaces of interconnects 8 to cover and protect the interconnects 8 with the protective film (metal film) 9, as shown in FIG. 1D. The present invention is applicable also to the case of forming a metal film (plated film) of a Co alloy, a Ni alloy, etc., for example, on a copper or silver surface to cover the copper or silver surface with the metal film.

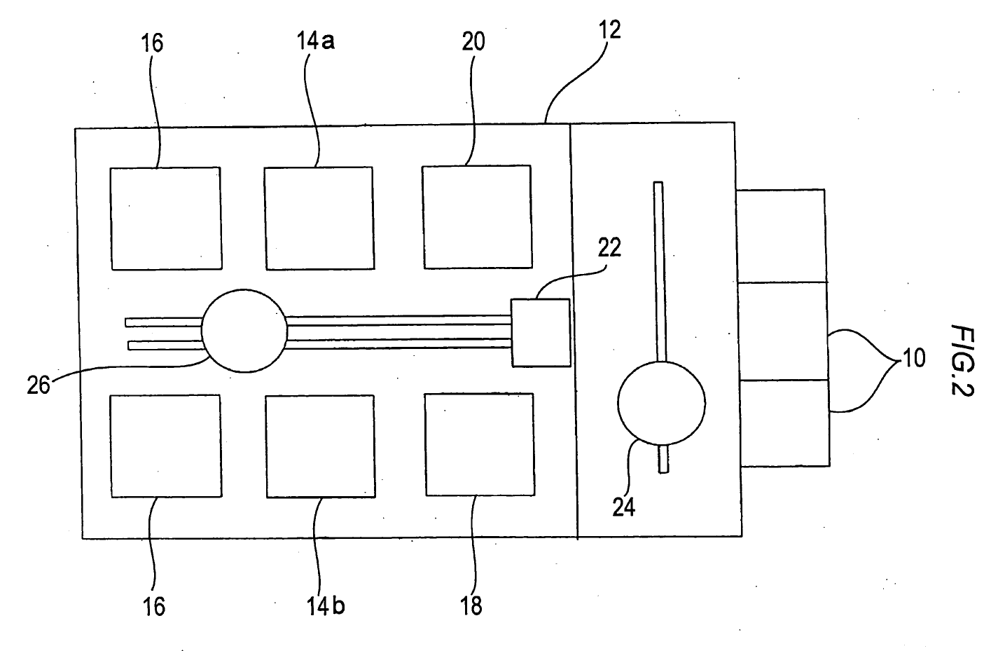

FIG. 2 shows a layout plan view of a substrate processing apparatus according to an embodiment of the present invention. As shown in FIG. 2, the substrate processing apparatus is provided with loading/unloading units 11 each for mounting substrate cassette which accommodate a number of substrates W, such as semiconductor devices, having interconnects 8 of, e.g., copper on the surfaces, as shown in FIG. 1C. In a rectangular apparatus frame 12 provided with a ventilation system, there are disposed a first pre-processing unit 14a for cleaning of a surface of a substrate W by processing solution and a second pre-processing unit 14b for applying a catalyst, such as Pd, to the surface of the substrate after cleaning. The first pre-processing unit 14a and the second pre-processing unit 14b use different processing solutions (chemical solutions) but have the same structure.

In the apparatus frame 12 are also disposed two electroless plating units 16 for carrying out electroless plating of the surface (surface to be plated) of the substrate W, a post-processing unit 18 for carrying out post-plating processing of the substrate W to enhance the selectivity of a protective film (alloy film) 9 (see FIG. 1D) which has been formed by electroless plating on the surfaces of interconnects 8, a drying unit 20 for drying the substrate W after the post-processing, and a temporary resting stage 22. Further, a first substrate transport robot 24 for transferring the substrate W between the substrate cassette set in the loading/unloading unit 10 and the temporary resting stage 22, and a second substrate transport robot 26 for transferring the substrate W between the temporary resting stage 22 and the unit 14a, 14b, 16, 18 or 20 are respectively disposed movably in the apparatus frame 12.

Next, there will be described below the details of various units provided in the substrate processing apparatus shown in FIG. 2.

The pre-processing unit 14a(14b) employs a two-liquid separation system to prevent the different liquids from being mixed with each other. While a peripheral portion of a lower surface of the substrate W, which is a surface to be processed (front face), transported in a face-down manner is sealed, the substrate W is fixed by pressing a back surface of the substrate.

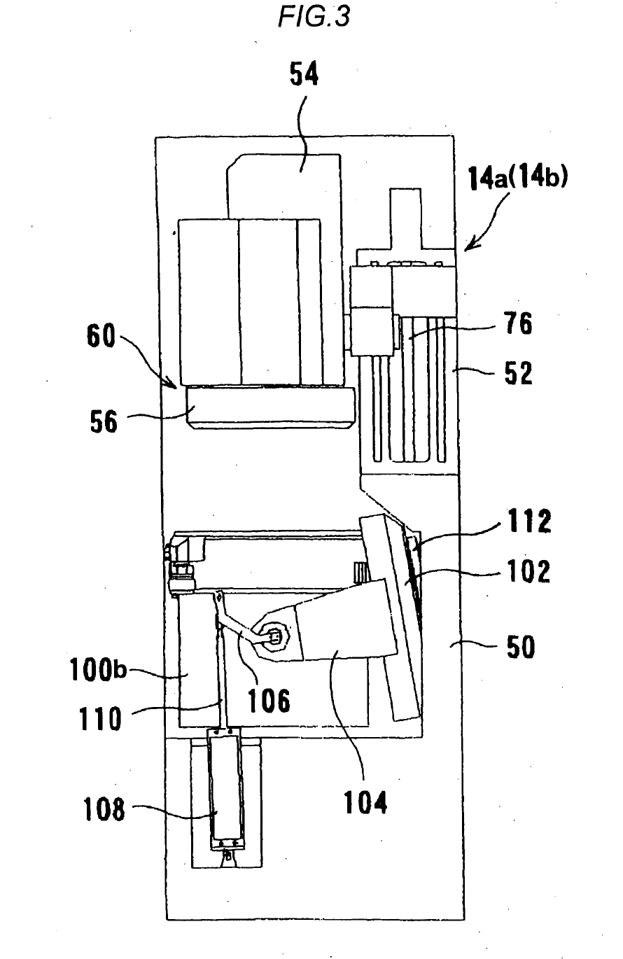

As shown in FIGS. 3 through 6, the pre-processing unit 14a (14b) includes a fixed frame 52 that is mounted on the upper part of a frame 50, and a movable frame 54 that moves up and down relative to the fixed frame 52. A processing head 60, which includes a bottomed cylindrical housing portion 56, opening downwardly, and a substrate holder 58, is suspended from and supported by the movable frame 54. In particular, a head-rotating servomotor 62 is mounted to the movable frame 54, and the housing portion 56 of the processing head 60 is coupled to the lower end of the downward-extending output shaft (hollow shaft) 64 of the servomotor 62.

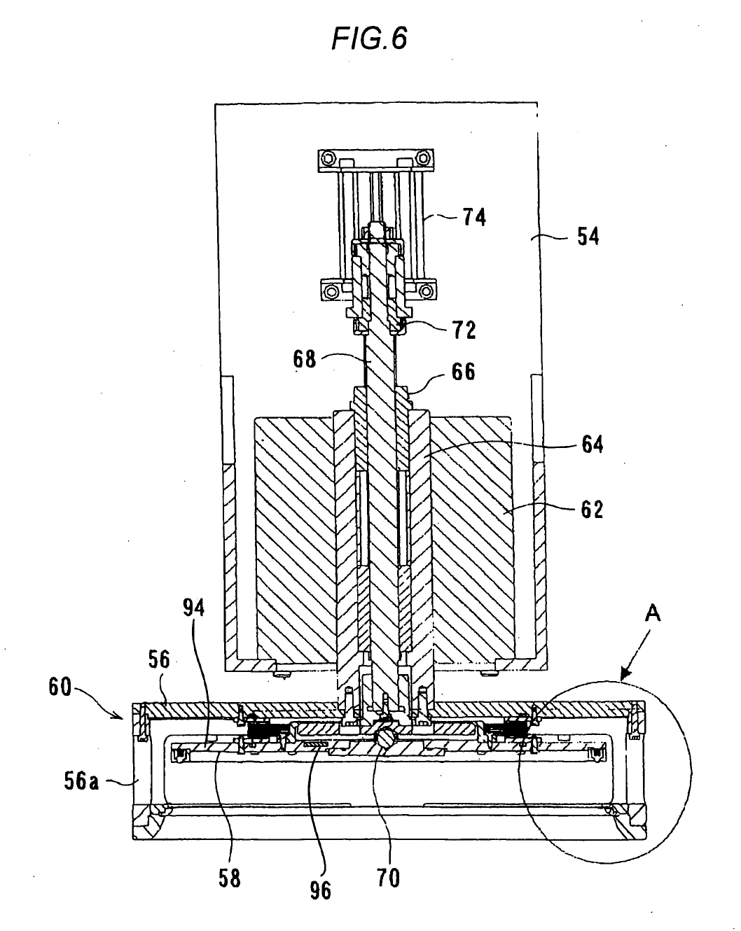

As shown in FIG. 6, a vertical shaft 68, which rotates together with the output shaft 64 via a spline 66, is inserted in the output shaft 64, and the substrate holder 58 of the processing head 60 is coupled to the lower end of the vertical shaft 68 via a ball joint 70. The substrate holder 58 is positioned within the housing portion 56. The upper end of the vertical shaft 68 is coupled via a bearing 72 and a bracket to a fixed ring-lifting cylinder 74 secured to the movable frame 54. Thus, by the actuation of the cylinder 74, the vertical shaft 68 moves vertically independently of the output shaft 64.

Linear guides 76, which extend vertically and guide vertical movement of the movable frame 54, are mounted to the fixed frame 52, so that, by the actuation of a head-lifting cylinder (not shown), the movable frame 54 moves vertically by the guide of the linear guides 76.

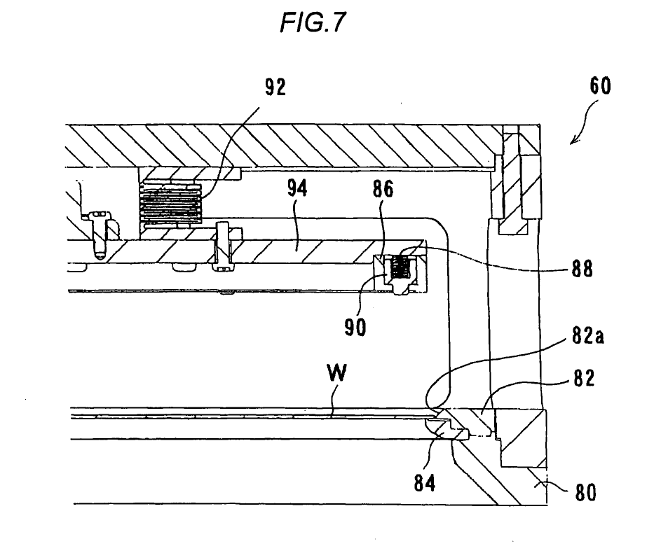

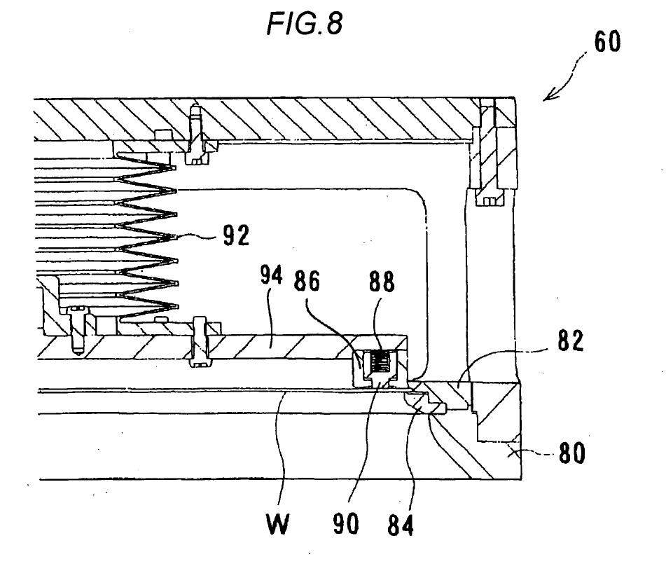

Substrate insertion windows 56a for inserting the substrate W into the housing portion 56 are formed in the circumferential wall of the housing portion 56 of the processing head 60. Further, as shown in FIGS. 7 and 8, a seal ring 84 is provided in the lower portion of the housing portion 56 of the processing head 60, an outer peripheral portion of the seal ring 84 being sandwiched between a main frame 80 made of, e.g., PEEK and a guide frame 82. The seal ring 84 is provided to make contact with a peripheral portion of the lower surface of the substrate W to seal the peripheral portion.

On the other hand, a substrate fixing ring 86 is fixed to a peripheral portion of the lower surface of the substrate holder 58. Each columnar pusher 90 protrudes downwardly from the lower surface of the substrate fixing ring 86 by the elastic force of a spring 88 disposed within the substrate fixing ring 86 of the substrate holder 58. Further, a flexible cylindrical bellows-like plate 92 made of, e.g., Teflon (registered trademark) is disposed between the upper surface of the substrate holder 58 and the upper wall of the housing portion 56 to hermetically seal therein.

Further, the substrate holder 58 includes a cover plate 94 covering the upper surface of the substrate held by the substrate holder 58. In the interior of the cover plate 94 is provided a cooling section 96 (see FIG. 6) comprised of, for example, a peltiert device, for cooling the substrate holder 58 to a temperature of, for example, not more than 10° C.

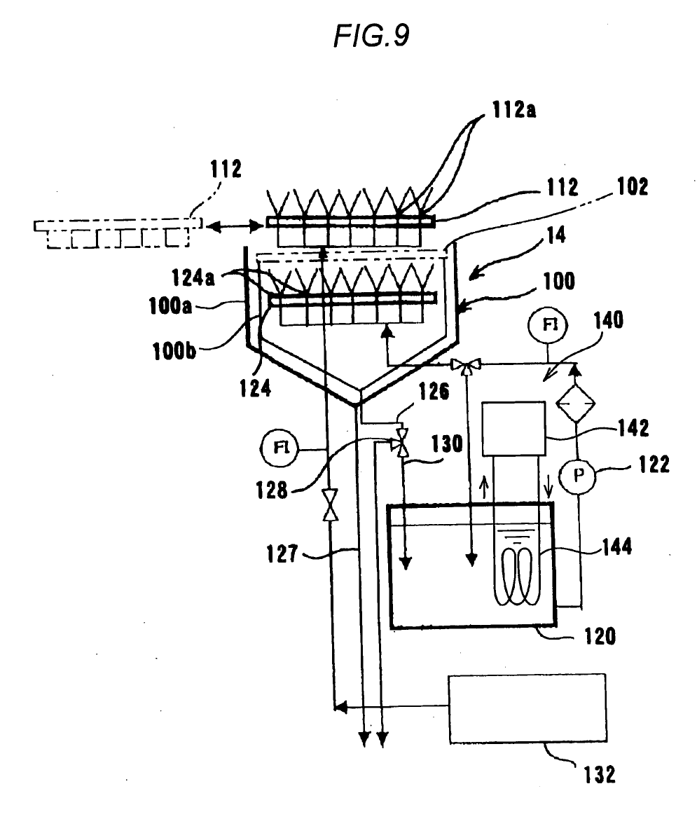

In association with the cooling section 96, it is possible to provide a cooling apparatus 140 (see FIG. 9) for adjusting the temperature of the substrate holder 58 to a predetermined temperature of not more than 10° C. As shown in FIG. 9, the cooling apparatus 140 includes a heat exchanger 142 for producing cooling water by heat exchange with a liquid, and a cooling water tube 144 extending from the heat exchanger 142. The cooling water tube 144, at its terminal, communicates with the cooling section 96, so that the cooling water, cooled by the heat exchanger 142, flows through the cooing water tube 144 and makes heat exchange with the substrate holder 58 whereby the substrate is cooled.

When the substrate holder 58 is in a raised position, a substrate W is inserted from the substrate insertion window 56a into the housing portion 56. The substrate W is then guided by a tapered surface 82a provided in the inner circumferential surface of the guide frame 82, and positioned and placed at a predetermined position on the upper surface of the seal ring 84a. In this state, the substrate holder 58 is lowered so as to bring the pushers 90 of the substrate fixing ring 86 into contact with the upper surface of the substrate W. The substrate holder 58 is further lowered so as to press the substrate W downwardly by the elastic forces of the springs 88, thereby forcing the seal ring 84a to make pressure contact with a peripheral portion of the front surface (lower surface) of the substrate W to seal the peripheral portion while nipping the substrate W between the housing portion 56 and the substrate holder 58 to hold the substrate W.

When the head-rotating servomotor 62 is driven while the substrate W is thus held by the substrate holder 58, the output shaft 64 and the vertical shaft 68 inserted in the output shaft 64 rotate together via the spline 66, whereby the substrate holder 58 rotates together with the housing portion 56. By cooling the substrate holder 58 to a temperature of not more than 10° C., the substrate W held by the substrate holder 58 can be cooled at a temperature of not more than 15° C.

At a position below the processing head 60, there is provided an upward-open processing tank 100 comprising an outer tank 100a and an inner tank 100b (see FIG. 9) that have a slightly larger inner diameter than the outer diameter of the processing head 60. A pair of leg portions 104, each of which is mounted to a lid 102, is rotatably supported on the outer circumferential portion of the inner tank 100b. Further, a crank 106 is integrally coupled to each leg portion 104, and the free end of the crank 106 is rotatably coupled to the rod 110 of a lid-moving cylinder 108. Thus, by the actuation of the lid-moving cylinder 108, the lid 102 moves between a processing position, at which the lid 102 covers the top opening of the inner tank 100b of the processing tank 100, and a retreat position beside the inner tank 100b. In the surface (upper surface) of the lid 102, there is provided a nozzle plate 112 having a large number of spray nozzles 112a for spraying outwardly (upwardly), for example, pure water.

Further, as shown in FIG. 9, a nozzle plate 124, having a plurality of spray nozzles 124a for spraying upwardly a processing solution, supplied from a processing solution tank 120 by driving the processing solution pump 122, is provided in the inner tank 100b of the processing tank 100 in such a manner that the spray nozzles 124a are equally distributed over the entire surface of the cross section of the inner tank 100b. A drainpipe 126 for draining a processing solution (waste liquid) to the outside is connected to the bottom of the inner tank 100b. A three-way valve 128 is provided in the drainpipe 126, and the processing solution (waste liquid) is returned to the processing solution tank 120 through a return pipe 130 connected to one of ports of the three-way valve 128 to recycle the processing solution, as needed.

In association with the processing solution tank 120, the above-described cooling apparatus 140, including the heat exchanger 142 for producing cooling water by heat exchange with a liquid, and the cooling water tube 144 extending from the heat exchanger 142, is provided for adjusting the temperature of the processing solution in the processing solution tank 120 to a predetermined temperature of not more than 15° C. The terminal portion of the cooling water tube 144 is immersed in the processing solution in the processing solution tank 120, so that the cooling water, cooled by the heat exchanger 142, flows through the cooing water tube 144 and makes heat exchange with the processing solution in the processing solution tank 120, whereby the processing solution is cooled. The temperature of the processing solution is preferably 4 to 15° C., more preferably 6 to 10° C.

Though in this embodiment is used the cooling apparatus which cools the processing solution in the processing solution tank 120 by making heat exchange with cooling water, it is, of course, possible to use a cooling device, such as a peltiert device, embedded in the wall of the processing solution tank 120 to cool the processing solution in the processing solution tank 120.

A cleaning solution comprising an inorganic acid, such as HF, H₂SO₄ or HCl, or an organic acid, such as oxalic acid or citric acid, or a mixture thereof is used as a processing solution in the first pre-processing unit 14a. The processing solution (cleaning solution) is sprayed toward the surface of the substrate to remove, e.g., an oxide film formed on surfaces of interconnects 8 (see FIG. 1C) and thereby activate the surfaces and, at the same time, remove CMP residues, such as copper, remaining on the surface of the insulating film 2, thereby preventing a metal film from being formed on the surface of the insulating film 2. The amount of dissolved oxygen in the processing solution is preferably not more than 3 ppm. This can prevent oxidation of the substrate surface by oxygen contained in the processing solution, thus preventing adverse effects of surface oxidation on the electric properties of interconnects after the activation processing.

A catalyst application solution at least containing a catalyst metal salt and a pH regulator is used in the second pre-processing unit 14b. As with the above processing (cleaning) solution, the amount of dissolved oxygen in the catalyst application solution (processing solution) is preferably not more than 3 ppm. The catalyst metal salt is contained in the catalyst application solution (processing solution) in an amount of, for example, 0.005 to 10 g/L. The catalyst metal of the catalyst metal salt is, for example, at least one of Pd, Pt, Ru, Co, Ni, Au and Ag. Of these metals, Pd is preferably used from the viewpoints of reaction rate, easy control of reaction, etc.

The pH regulator maybe an acid selected from hydrochloric acid, sulfuric acid, nitric acid, citric acid, oxalic acid, formic acid, acetic acid, maleic acid, malic acid, adipic acid, pimelic acid, glutaric acid, succinic acid, fumaric acid and phthalic acid, or a base selected from aqueous ammonium solution, KOH, tetramethylammonium hydride and tetraethylammonium hydride. The pH of the catalyst application solution (processing solution) may be 0 to 6, and is adjusted by the pH regulator, e.g., within the range of −0.2 to +0.2 around a target value.

Further, according to this embodiment, the nozzle plate 112 provided on the surface (upper surface) of the lid 102 is connected to a rinsing liquid supply source 132 for supplying a rinsing liquid, such as pure water. A rinsing liquid (pure water), having a dissolved oxygen content of not more than 3 ppm, is thus sprayed toward the surface of the substrate. Further, a drainpipe 127 is connected also to the bottom of the outer tank 100a.

Accordingly, the processing head 60 holding a substrate W is lowered to thereby close the top opening of the outer tank 100a of the processing tank 100 with the processing head 60, and a processing solution whose temperature is adjusted to a predetermined temperature of not more than 15° C., which is either the cleaning solution in the case of the first pre-processing unit 14a or the catalyst processing solution in the case of the second pre-processing unit 14b, is then sprayed from the spray nozzles 124a of the nozzle plate 124 disposed in the inner tank 100b of the processing tank 100 toward the substrate W. whereby the processing solution can be supplied uniformly onto the entire lower surface (surface to be processed) of the substrate W. Further, the processing solution can be discharged from the drainpipe 126 while preventing the processing solution from scattering out of the inner tank 100b.

Further, by raising the processing head 60 and closing the top opening of the inner tank 100b of the processing tank 100 with the lid 102, and then spraying a rinsing liquid from the spray nozzles 112a of the nozzle plate 112 disposed on the upper surface of the lid 102 toward the substrate W held in the processing head 60, the rinsing processing (cleaning processing) is carried out to remove the processing solution remaining on the surface of the substrate W. Because the rinsing liquid passes through the clearance between the outer tank 100a and the inner tank 100b and is discharged through the drainpipe 127, the rinsing liquid is prevented from flowing into the inner tank 100b and from being mixed with the processing solution.

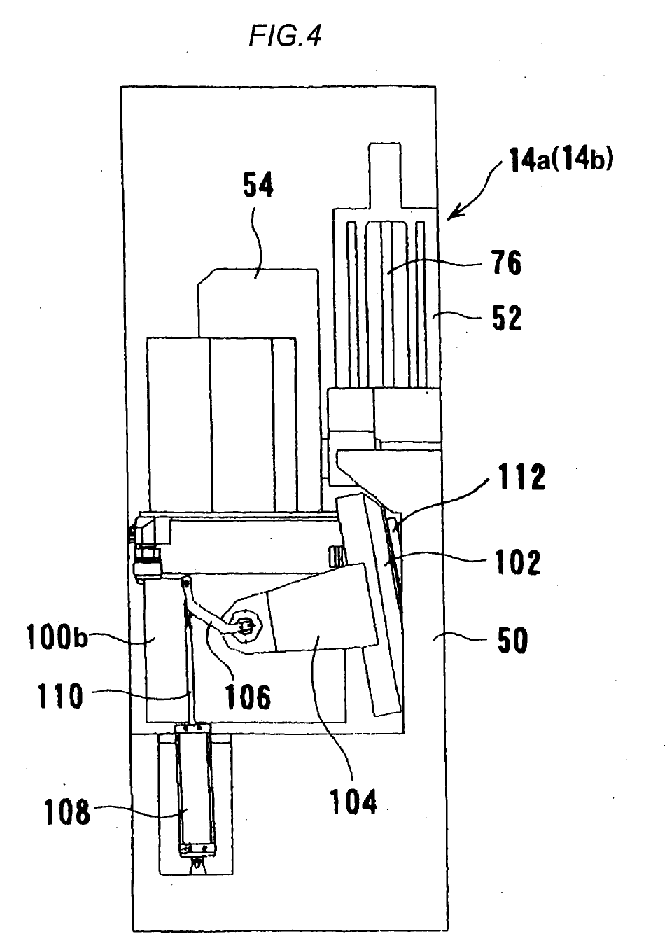

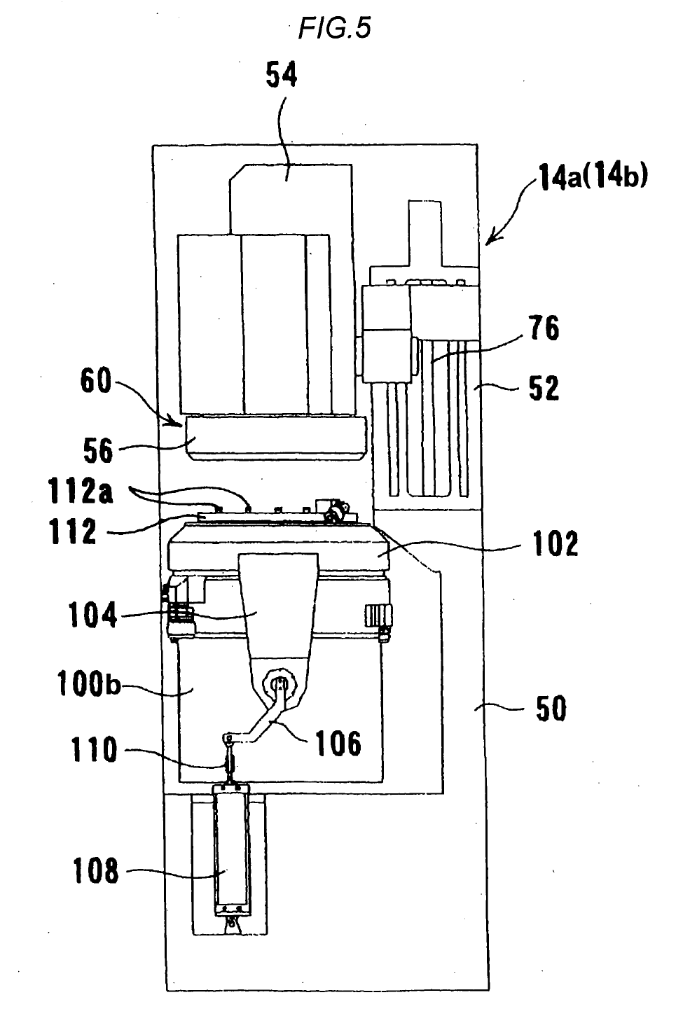

According to this pre-processing unit 14a(14b), as shown in FIG. 3, when the processing head 60 is raised, the substrate W is inserted into the processing head 60 and held. Thereafter, as shown in FIG. 4, the processing head 60 is lowered to the position at which it closes the top opening of the inner tank 100b of the processing tank 100. Then, while rotating the substrate W held by the processing head 60 by rotating the processing head, a processing solution whose temperature is adjusted to not more than 15° C., i.e., a cleaning solution or a catalyst processing solution, sprayed from the spray nozzles 124a of the nozzle plate 124 disposed in the inner tank 100b of the processing tank 100 toward the substrate W, thereby spraying the processing solution uniformly onto the entire surface of the substrate W. The processing head 60 is raised and stopped at a predetermined position and, as shown in FIG. 5, the lid 102 in the retreat position is moved to the position at which it covers the top opening of the inner tank 100b of the processing tank 100. A rinsing liquid is then sprayed from the spray nozzles 112a of the nozzle plate 112 disposed on the upper surface of the lid 102 toward the rotating substrate W held in the processing head 60. The processing by the processing solution and the rinsing processing by the rinsing liquid of the substrate W can thus be carried out successively while avoiding mixing of the two liquids.

In this embodiment, the first pre-processing unit 14a and the second pre-processing unit 14b have the same construction. However, for the first pre-processing unit 14a which uses a cleaning solution comprising an inorganic acid, such as H₂SO₄ or HCl, or an organic acid, such as oxalic acid or citric acid, or a mixture thereof, as a processing solution, it is not always necessary to adjust the temperature of the processing solution (cleaning solution) to a predetermined temperature of not more than 15° C. In such a case, it is possible to use the first pre-processing unit 14a from which the cooling section 96 and the cooling apparatus 140 are omitted.

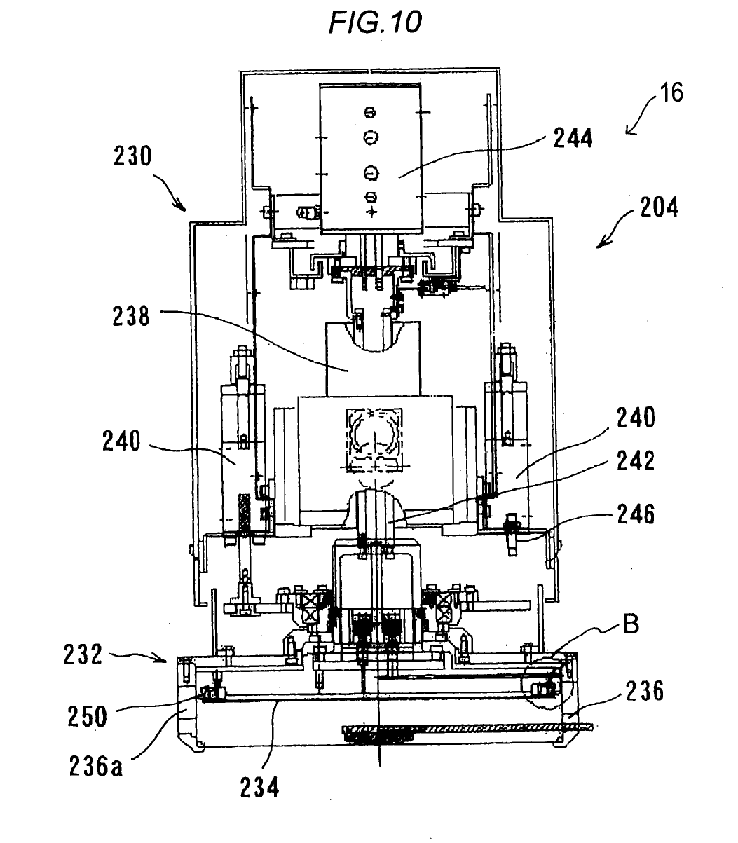

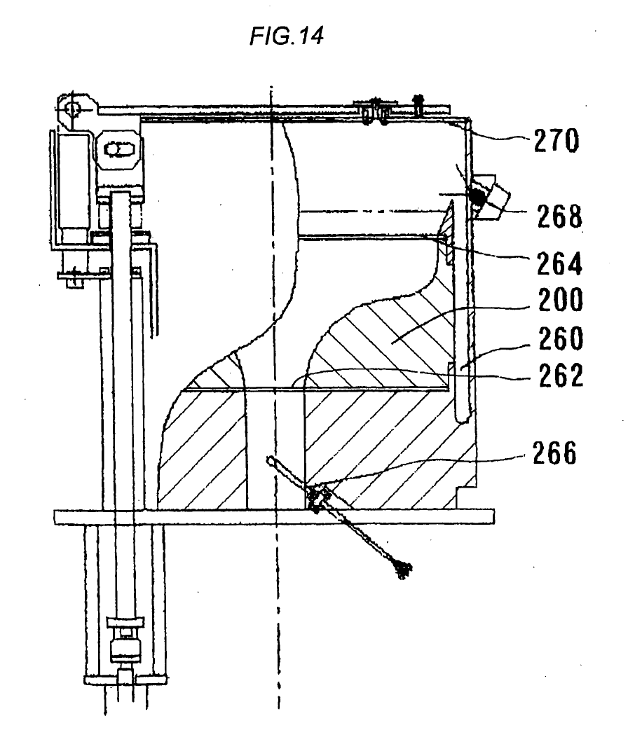

FIGS. 10 through 14 show an electroless plating unit 16. This electroless plating unit 16 includes a plating tank 200 (see FIG. 14) and a substrate head 204, disposed above the plating tank 200, for detachably holding a substrate W.

As shown in detail in FIG. 10, the processing head 204 has a housing portion 230 and a head portion 232. The head portion 232 mainly comprises a suction head 234 and a substrate receiver 236 for surrounding the suction head 234. The housing portion 230 accommodates therein a substrate rotating motor 238 and substrate receiver drive cylinders 240. The substrate rotating motor 238 has an output shaft (hollow shaft) 242, having an upper end coupled to a rotary joint 244, and a lower end coupled to the suction head 234 of the head portion 232. The substrate receiver drive cylinders 240 have respective rods coupled to the substrate receiver 236 of the head portion 232. Stoppers 246 are provided in the housing portion 230 for mechanically limiting upward movement of the substrate receiver 236.

The suction head 234 and the substrate receiver 236 are operatively connected to each other by a splined structure such that when the substrate receiver drive cylinders 240 are actuated, the substrate receiver 236 vertically moves relative to the suction head 234, and when the substrate rotating motor 238 is driven, the output shaft 242 thereof is rotated to rotate the suction head 234 with the substrate receiver 236.

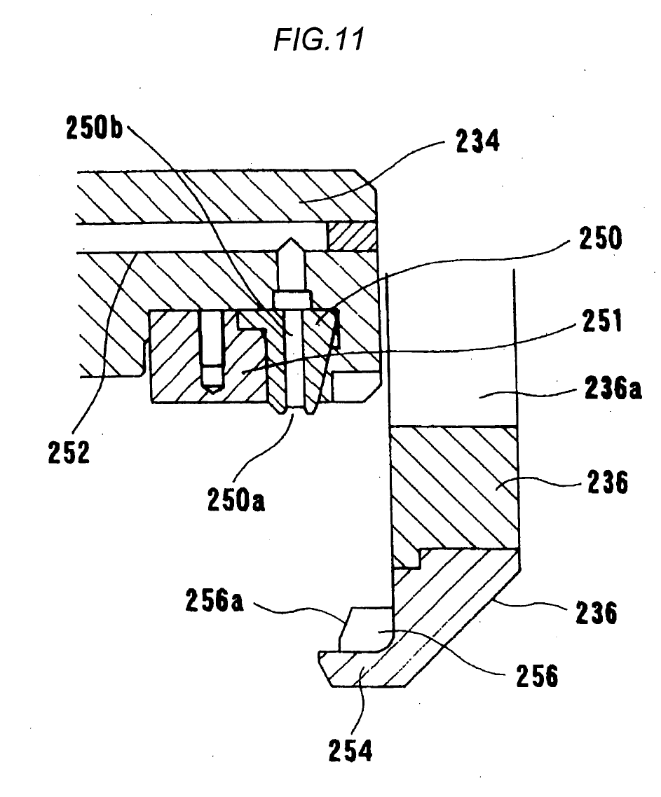

As shown in detail in FIGS. 11 through 13, a suction ring 250, for attracting and holding a substrate W against its lower surface to be sealed, is mounted on a lower circumferential edge of the suction head 234 by a presser ring 251. The suction ring 250 has a recess 250a continuously defined in a lower surface thereof in a circumferential direction and in communication with a vacuum line 252 extending through the suction head 234 by a communication hole 250b that is defined in the suction ring 250. When the recess 250a is evacuated, the substrate W is attracted to and held by the suction ring 250. Because the substrate W is attracted under vacuum to the suction ring 250 along a radially narrow circumferential area provided by the recess 250a, any adverse effects such as a deflection caused by the vacuum on the substrate W are minimized. When the suction ring 250 is dipped in the plating solution (processing solution), not only the surface (lower surface) of the substrate W, but also its circumferential edge, can be dipped in the plating solution. The substrate W is released from the suction ring 250 by introducing N₂ into the vacuum line 252.

The substrate receiver 236 is in the form of a downwardly open, hollow bottomed cylinder having substrate insertion windows 236a defined in a circumferential wall thereof for inserting therethrough the substrate W into the substrate receiver 236. The substrate receiver 236 also has an annular ledge 254 projecting inwardly from its lower end, and annular protrusions 256 disposed on an upper surface of the annular ledge 254 and each having a tapered inner circumferential surface 256a for guiding the substrate W.

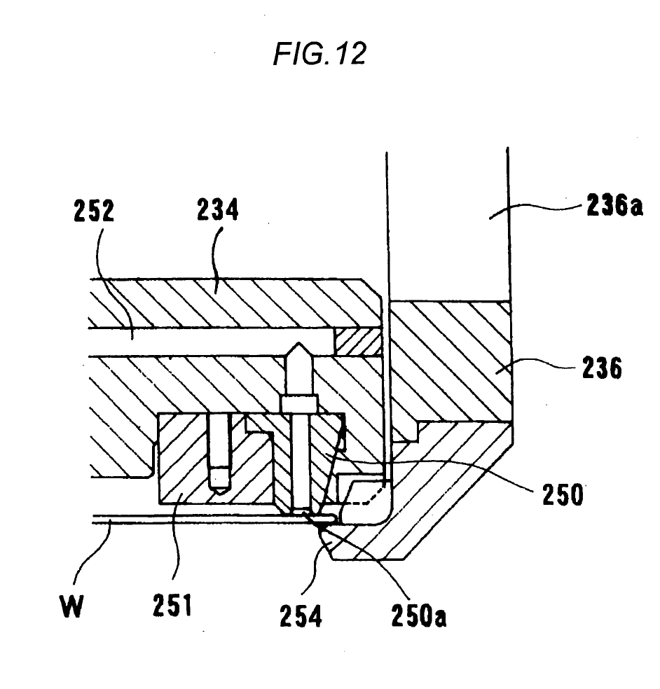

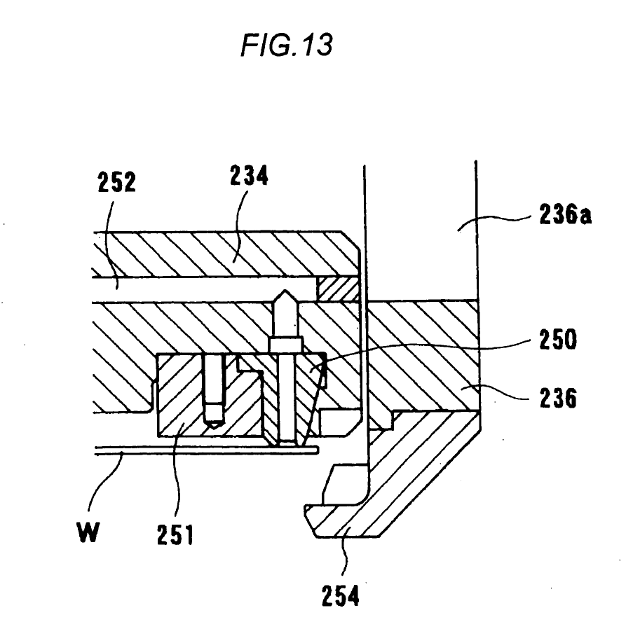

As shown in FIG. 11, when the substrate receiver 236 is lowered, the substrate W is inserted through the substrate insertion window 236a into the substrate receiver 236. The substrate W thus inserted is guided by the tapered surfaces 256a of the protrusions 256 and positioned thereby onto the upper surface of the ledge 254 in a predetermined position thereon. The substrate receiver 236 is then elevated until it brings the upper surface of the substrate W placed on the ledge 254 into abutment against the suction ring 250 of the suction head 234, as shown in FIG. 12. Then, the recess 250a in the vacuum ring 250 is evacuated through the vacuum line 252 to attract the substrate W while sealing the upper peripheral edge surface of the substrate W against the lower surface of the suction ring 250. When plating is performed, as shown in FIG. 13, the substrate receiver 236 is lowered several mm to space the substrate W from the ledge 254, keeping the substrate W attracted only by the suction ring 250. The substrate W now has its lower peripheral edge surface prevented from not being plated because it is held out of contact with the ledge 254.

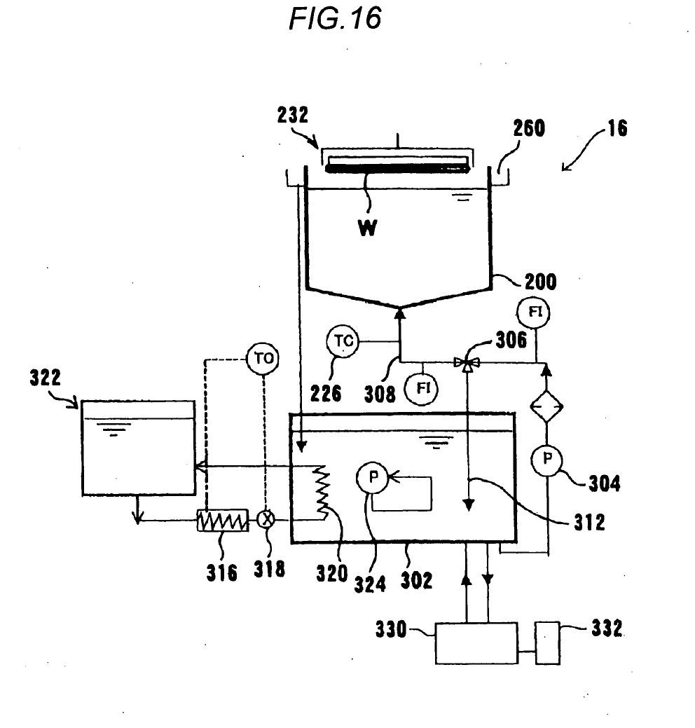

FIG. 14 shows the details of the plating tank 200. The plating tank 200 is connected at the bottom to a plating solution supply pipe 308 (see FIG. 16), and is provided in the peripheral wall with a plating solution recovery groove 260. In the plating tank 200, there are disposed two current plates 262, 264 for stabilizing the flow of a plating solution flowing upward. A thermometer 266, for measuring the temperature of the plating solution introduced into the plating tank 200, is disposed at the bottom of the plating tank 200. Further, on the outer surface of the peripheral wall of the plating tank 200 and at a position slightly higher than the liquid level of the plating solution held in the plating tank 200, there is provided a spray nozzle 268 for spraying a stop liquid which is a neutral liquid having a pH of 6 to 7.5, for example, pure water, inwardly and slightly upwardly in the normal direction. After plating, the substrate W held in the head portion 232 is raised and stopped at a position slightly above the surface of the plating solution. In this state, pure water (stop liquid) is immediately sprayed from the spray nozzle 268 toward the substrate W to cool the substrate W, thereby preventing progress of plating by the plating solution remaining on the substrate W.

Further, at the top opening of the plating tank 200, there is provided a plating tank cover 270 capable of opening and closing for closing the top opening of the plating tank 200 in a non-plating time, such as idling time, so as to prevent unnecessary evaporation of the plating solution from the plating tank 200.

As shown in FIG. 16, a plating solution supply pipe 308, extending from a plating solution storage tank 302 and having a plating solution supply pump 304 and a three-way valve 306, is connected to the plating tank 200 at the bottom of the plating tank 200. With this arrangement, during a plating process, a plating solution is supplied into the plating tank 200 from the bottom of the plating tank 200, and the overflowing plating solution is recovered by the plating solution storage tank 302 through the plating solution recovery groove 260. Thus, the plating solution can be circulated. A plating solution return pipe 312, for returning the plating solution to the plating solution storage tank 302, is connected to one of the ports of the three-way valve 306. Thus, the plating solution can be circulated even in a standby condition of plating, and a plating solution circulating system is constructed. The plating solution in the plating solution storage tank 302 is always circulated through the plating solution circulating system, and hence a lowering rate of the concentration of the plating solution can be reduced and the number of the substrates W, which can be processed, can be increased, compared with the case in which the plating solution is simply stored.

The thermometer 266 provided in the vicinity of the bottom of the plating tank 200 measures a temperature of the plating solution introduced into the plating tank 200, and controls a heater 316 and a flow meter 318, both described below, based on the measured result.

Specifically, in this embodiment, there are provided a heating device 322 for heating the plating solution indirectly by a heat exchanger 320 which is provided in the plating solution in the plating solution storage tank 302 and uses water as a heating medium which has been heated by a separate heater 316 and has passed through the flow meter 318, and a stirring pump 324 for mixing the plating solution by circulating the plating solution in the plating solution storage tank 302. This is because in the plating, in some cases, the plating solution is used at a high temperature (about 80° C.), and the structure should cope with such cases. This method can prevent very delicate plating solution from being mixed with foreign matter or the like, as compared to an in-line heating method.

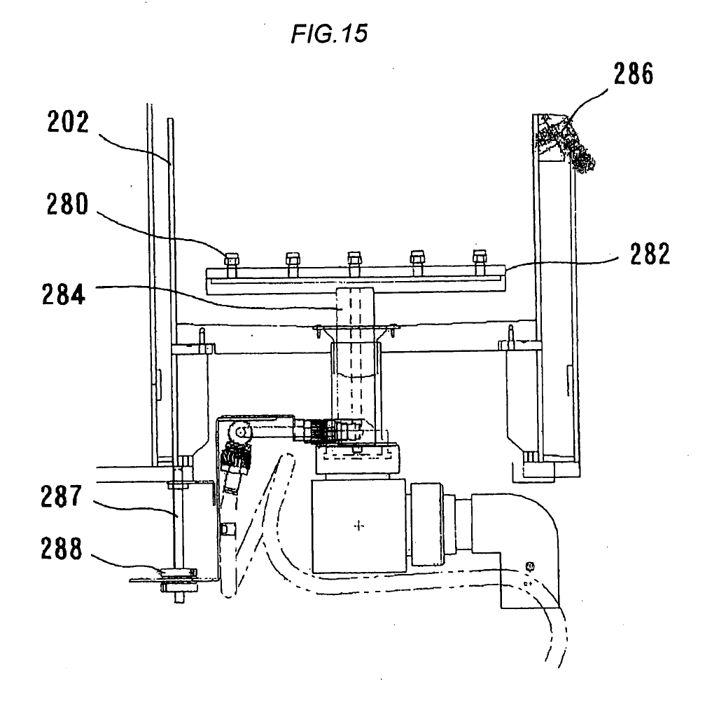

FIG. 15 shows the details of a cleaning tank 202 provided beside the plating tank 200. At the bottom of the cleaning tank 202, there is provided a nozzle plate 282 having a plurality of spray nozzles 280, attached thereto, for upwardly spraying a rinsing liquid such as pure water. The nozzle plate 282 is coupled to an upper end of a nozzle lifting shaft 284. The nozzle lifting shaft 284 can be moved vertically by changing the position of engagement between a nozzle position adjustment screw 287 and a nut 288 engaging the screw 287 so as to optimize the distance between the spray nozzles 280 and a substrate W located above the spray nozzles 280.

Further, on the outer surface of the peripheral wall of the cleaning tank 202 and at a position above the spray nozzles 280, there is provided a head cleaning nozzle 286 for spraying a cleaning liquid, such as pure water, inwardly and slightly downwardly onto at least a portion, which was in contact with the plating solution, of the head portion 232 of the substrate head 204.

In operating the cleaning tank 202, the substrate W held in the head portion 232 of the substrate head 204 is located at a predetermined position in the cleaning tank 202. A cleaning liquid (rinsing liquid), such as pure water, is sprayed from the spray nozzles 280 to clean (rinse) the substrate W, and at the same time, a cleaning liquid, such as pure water, is sprayed from the head cleaning nozzle 286 to clean at least a portion, which was in contact with the plating solution, of the head portion 232 of the substrate head 204, thereby preventing a deposit from accumulating on that portion which was immersed in the plating solution.

According to this electroless plating unit 16, when the substrate head 204 is in a raised position, the substrate W is held by vacuum attraction in the head portion 232 of the substrate head 204, as described above, while the plating solution in the plating tank 200 is allowed to circulate.

When plating is performed, the plating tank cover 270 of the plating tank 200 is opened, and the substrate head 204 is lowered, while the substrate head 204 is rotating, so that the substrate W held in the head portion 232 is immersed in the plating solution in the plating tank 200.

After immersing the substrate W in the plating solution for a predetermined time, the substrate head 204 is raised to pull the substrate W from the plating solution in the plating tank 200 and, as needed, pure water (stop liquid) is immediately sprayed from the spray nozzle 268 toward the substrate W to cool the substrate W, as described above. The substrate head 204 is further raised to lift the substrate W to a position above the plating tank 200, and the rotation of the substrate head 204 is stopped.

Next, while the substrate W is held by vacuum attraction in the head portion 232 of the substrate head 204, the substrate head 204 is moved to a position right above the cleaning tank 202. While rotating the substrate head 204, the substrate head 204 is lowered to a predetermined position in the cleaning tank 202. A cleaning liquid (rinsing liquid), such as pure water, is sprayed from the spray nozzles 280 to clean (rinse) the substrate W, and at the same time, a cleaning liquid, such as pure water, is sprayed from the head cleaning nozzle 286 to clean at least a portion, which was in contact with the plating solution, of the head portion 232 of the substrate head 204.

After completion of cleaning of the substrate W, the rotation of the substrate head 204 is stopped, and the substrate head 204 is raised to lift the substrate W to a position above the cleaning tank 202. Further, the substrate head 204 is moved to the transfer position between the second substrate transport robot 26 and the substrate head 204, and the substrate W is transferred to the second substrate transport robot 26, and is transported to a next process.

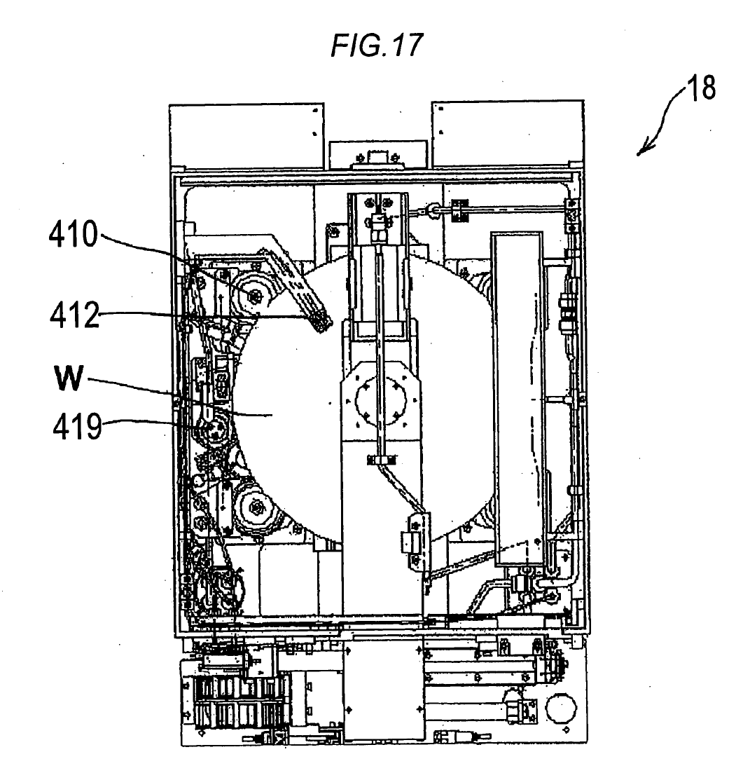

FIG. 17 shows the post-processing unit 18. The post-processing unit 18 is a unit for forcibly removing particles and unnecessary matters on the substrate W with a roll-shaped brush, and includes a plurality of rollers 410 for holding the substrate W by nipping its peripheral portion, a chemical nozzle 412 for supplying a chemical solution (two lines) to the front surface of the substrate W held by the rollers 410, and a pure water nozzle (not shown) for supplying pure water (one line) to the back surface of the substrate W.

In operation, the substrate W is held by the rollers 410 and a roller drive motor is driven to rotate the rollers 410, thereby rotate the substrate W, while predetermined chemical liquids are supplied from the chemical nozzle 412 and the pure water nozzle to the front and back surfaces of the substrate W, and the substrate W is nipped between not-shown upper and lower roll sponges (roll-shaped brushes) at an appropriate pressure, thereby cleaning the substrate W. It is also possible to rotate the roll sponges independently so as to increase the cleaning effect.

The post-processing unit 18 also includes a sponge (PFR) 419 that rotates while contacting the edge (peripheral portion) of the substrate W, thereby scrub-cleaning the edge of the substrate W.

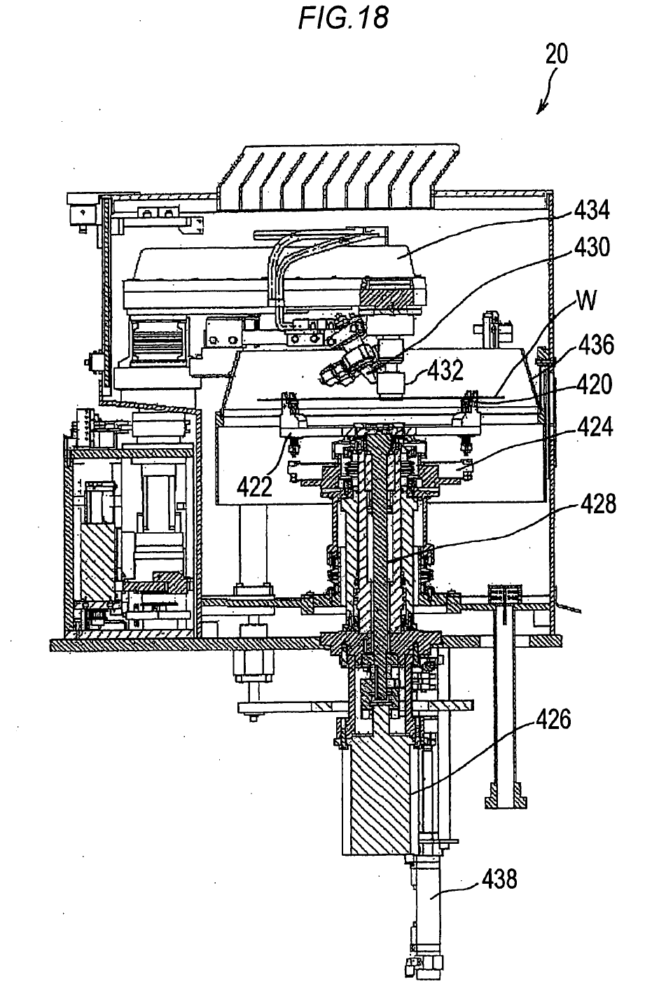

FIG. 18 shows the drying unit 20. The drying unit 20 is a unit for first carrying out chemical cleaning and pure water cleaning of the substrate W, and then fully drying the cleaned substrate W by spindle rotation, and includes a substrate stage 422 provided with a clamping mechanism 420 for clamping an edge portion of the substrate W, and a substrate attachment/detachment lifting plate 424 for opening/closing the clamping mechanism 420. The substrate stage 422 is coupled to the upper end of a spindle 428 that rotates at a high speed by the actuation of a spindle rotating motor 426.

Further, positioned on the side of the upper surface of the substrate W clamped by the clamping mechanism 420, there are provided a mega-jet nozzle 430 for supplying pure water to which ultrasonic waves from a ultrasonic oscillator have been transmitted during its passage through a special nozzle to increase the cleaning effect, and a rotatable pencil-type cleaning sponge 432, both mounted to the free end of a pivot arm 434. In operation, the substrate W is clamped by the clamping mechanism 420 and rotated, and the pivot arm 434 is pivoted while pure water is supplied from the mega-jet nozzle 430 to the cleaning sponge 432 and the cleaning sponge 432 is rubbed against the front surface of the substrate W, thereby cleaning the front surface of the substrate W. A cleaning nozzle (not shown) for supplying pure water is provided also on the side of the back surface of the substrate W, so that the back surface of the substrate W can also be cleaned with pure water sprayed from the cleaning nozzle.

The thus-cleaned substrate W is spin-dried by rotating the spindle 428 at a high speed.

A cleaning cup 436, surrounding the substrate W clamped by the clamping mechanism 420, is provided for preventing scattering of a processing solution. The cleaning cup 436 is designed to move up and down by the actuation of a cleaning cup lifting cylinder 438.

It is also possible to provide the drying unit 20 with a cavi-jet function utilizing cavitation.

A description will now be made of a series of substrate processing (electroless plating) steps carried out by this substrate processing apparatus. The following description illustrates the case of selectively forming a protective film (cap material) 9 of COWP alloy to protect interconnects 8, as shown in FIG. 1.

First, one substrate W is taken by the first substrate transport robot 24 out of the cassette set in the loading/unloading unit 10 and housing substrates W with their front surfaces facing upwardly (face up), each substrate W having been subjected to the formation of interconnects 8 on the surface, as shown in FIG. 1C, and the substrate W is transported to the temporary resting stage 22 and placed on it. The substrate W on the temporary resting stage 22 is transported by the second substrate transport robot 26 to the first pre-processing unit 14a.

In the first pre-processing unit 14a, the substrate W is held face down, and pre-cleaning of the front surface with a cleaning solution (processing solution) is carried out. In particular, the substrate W is held by the substrate holder 58, and then the processing head 60 is positioned at a position where it covers the top opening of the inner tank 100b, as shown in FIG. 4. The processing solution (cleaning solution) in the processing solution tank 120 is sprayed toward the substrate W from the spray nozzles 112a of the nozzle plate 112 disposed in the inner tank 100b, thereby etching away an oxide, etc. on the interconnects 8 and activating the surfaces of the interconnects 8 and, at the same time, removing CMP residues, such as copper, remaining on the insulating film 2. Thereafter, the processing head 60 is raised and the top of the inner tank 100b is covered with the lid 102, as shown in FIG. 5. A rinsing liquid, such as pure water, is then sprayed toward the substrate W from the spray nozzles 112a of the nozzle plate 112 provided on the lid 102, thereby cleaning (rinsing) the substrate W. Thereafter, the substrate W is transported by the second substrate transport robot 26 to the second pre-processing unit 14b.

In the second pre-processing unit 14b, the substrate W is held face down, and a catalyst application processing of the front surface with a catalyst application solution (processing solution) is carried out. In particular, the substrate W is held by the substrate holder 58, and then the processing head 60 is positioned at a position where it covers the top opening of the inner tank 100b, as shown in FIG. 4. The processing solution (catalyst application solution) in the processing solution tank 120 is sprayed toward the substrate W from the spray nozzles 112a of the nozzle plate 112 disposed in the inner tank 100b, thereby applying Pd as a catalyst to the surfaces of the interconnects 8, i.e., forming Pd seeds as catalyst seeds on the surfaces of the interconnects 8, thus activating the exposed surfaces of the interconnects 8. Thereafter, the processing head 60 is raised and the top of the inner tank 100b is covered with the lid 102, as shown in FIG. 5. A rinsing liquid, such as pure water, is then sprayed toward the substrate W from the spray nozzles 112a of the nozzle plate 112 provided on the lid 102, thereby cleaning (rinsing) the substrate W. Thereafter, the substrate W is transported by the second substrate transport robot 26 to the electroless plating unit 16.

Upon the activation processing in the first pre-processing unit 14a or the activation processing in the second pre-processing unit 14b, using the respective processing solutions, the temperature of the processing solution (cleaning solution or catalyst application solution) in the processing solution tank 120 is pre-adjusted to a predetermined temperature of not more than 15° C., preferably 4 to 15° C., more preferably 6 to 10° C. by the cooling apparatus 140. The processing solution, whose temperature has been adjusted to a predetermined temperature of not more than 15° C., is sprayed toward the substrate W. During the processing, the substrate holder 58 is cooled to not more than 10° C. by the cooling section 96 to cool the substrate W held by the substrate holder 58 to a predetermined temperature of not more than 15° C., so that the temperature of the processing solution, which has been adjusted to not more than 15° C., will not rise upon its contact with the substrate.

By thus carrying out an activation processing, such as application of a catalyst, of the interconnects 8 while controlling the rate of diffusion of a material, such as Pd, with a processing solution whose temperature is adjusted to not more than 15° C., corrosion of the interconnects 8 upon the activation processing can be minimized. Further, by adjusting the temperature of the processing solution to not more than 15° C. to control or decrease the rate of diffusion of a material, such as Pd, so that a reaction changes from reaction-controlled to diffusion-controlled, i.e., the reaction is determined not by the rate of the chemical reaction but by diffusion of a material, such as Pd, it becomes possible to carry out an activation processing of the surface of an interconnect pattern with a variation of pattern density while reducing the pattern-dependency of processing.

The time for spraying a processing solution is preferably not less than 15 seconds. By thus keeping a surface of a substrate in contact with the processing solution for not less than 15 seconds, an insufficient surface activation processing due to a decrease in the activation processing rate can be prevented. In the case of activation processing for surfaces of interconnects, it is preferred to carry out the activation processing in such a manner that the processing will not cause a rise of 5% or more in the resistance of the interconnects.

In the electroless plating unit 16, the substrate head 204 holding the substrate W face down is lowered to immerse the substrate W in the plating solution in the plating tank 200, thereby carrying out electroless plating (electroless CoWP cap plating) of the substrate. In particular, the substrate W is immersed in, e.g., a CoWP-plating solution at 80° C., e.g., for about 120 seconds to carry out selective electroless plating (electroless COWP cap plating) on the activated surfaces of the interconnects 8.

After pulling up the substrate W from the liquid surface of the plating solution, a stop liquid, such as pure water, is sprayed toward the substrate W from the spray nozzle 268, thereby replacing the plating solution on the surface of the substrate W with the stop solution and stopping electroless plating. The substrate head 204 holding the substrate W is then positioned at a predetermined position in the cleaning tank 202, and pure water is sprayed toward the substrate W from the spray nozzles 280 of the nozzle plate 282 in the cleaning, tank 202 to clean (rinse) the substrate W and, at the same time, pure water is sprayed from the cleaning nozzle 286 to the head portion 232 to clean the head portion 232. A protective film 9 of COWP alloy (see FIG. 1D) is thus formed selectively on the surfaces of interconnects 8 to protect the interconnects 8.

Next, the substrate W after the electroless plating is transported by the second substrate transport robot 26 to the post-processing unit 18, where the substrate W is subjected to post-plating processing (post-cleaning) to enhance the selectivity of the protective film (metal film) 9 formed on the surface of the substrate W and to thereby increase the yield. In particular, while applying a physical force to the surface of the substrate W, for example by roll scrub cleaning or pencil cleaning, a post-plating solution (chemical solution) is supplied to the surface of the substrate W to thereby completely remove plating residues, such as fine metal particles, remaining on the insulating film (interlevel dielectric film) 2, thus enhancing the selectivity of plating.

The substrate W after the post-plating processing is transported by the second substrate transport robot 26 to the drying unit 20, where the substrate W is rinsed, according to necessity, and is then spin-dried by rotating it at a high speed.

The substrate W after spin-drying is transported by the second substrate transport robot 26 to the temporary resting stage 22 and placed on it. The substrate W on the temporary resting stage 22 is returned by the first substrate transport robot 24 to the substrate cassette mounted in the loading/unloading unit 10.

Though in this embodiment copper (Cu) is used as an interconnect material, and a protective film 9 of CoWP alloy is formed selectively on copper interconnects 8, it is also possible to use a Cu alloy, Ag or an Ag alloy as an interconnect material and to use a film of CoWB, CoP, CoB, Co alloy, NiWP, NiWB, NiP, NiB or Ni alloy as a protective film 9.

Though in this embodiment the surfaces of interconnects 8 are activated and a protective film (metal film) 9 is formed selectively on the activated surfaces, it is also possible to activate surfaces of via holes 3 and interconnect recesses 4 shown in FIG. 1A, formed in a substrate, and form a metal film on the activated surfaces.

### EXAMPLE

A 200-mm wafer in which an isolated copper interconnect having a length of about 3 mm and a width of 0.16 μm, linearly connecting pads, and dense copper interconnects having a length of about 300 mm, arranged parallel to each other at a spacing of 0.16 μm and connecting pads, each interconnect having a width of 0.16 μm, are co-present, was prepared as a test sample. These interconnects were formed by forming a barrier layer of Ta and a copper seed layer by sputtering over the wafer surface with interconnect recesses formed therein, and then filling copper into the recesses by electroplating, followed by CMP to flatten the surface.

First, the sample substrate was immersed in oxalic acid (2 wt %) at room temperature (22° C.) for one minute, followed by cleaning with pure water. The sample was then immersed in a catalyst application solution (processing solution), which was a mixed solution of 0. 05 g/L PdSO₄ and 0.1 M H₂SO₄ and adjusted to a temperature lower than the room temperature by 10° C., for 30 seconds, followed by cleaning with pure water. Thereafter, the sample was immersed in a heated plating solution having the below-described composition for two minutes to form a protective film of CoWP alloy on the surfaces of the interconnects, followed by cleaning with pure water and drying.

Composition of plating solution (mol/L)

| | |
|---|---|
| CoSO₄•7H₂O | 0.05 |
| Na₃C₆H₅O₇•H₂O | 0.3 |
| H₃BO₃ | 0.25 |
| Na₂WO₄•H₂O | 0.002 |
| NaH₂PO₂ | 0.1 |
| pH | 9.0 |

In Comparative Example, the same sample as described above was prepared, and the sample was immersed in oxalic acid (2 wt %) at room temperature (22° C.) for one minute, followed by cleaning with pure water. The sample was then immersed in a catalyst application solution (processing solution), which was a mixed solution of 0.05 g/L PdSO₄ and 0.1 M H₂SO₄, at room temperature for 30 seconds, followed by cleaning with pure water. Thereafter, the sample was immersed in a heated plating solution having the above-described composition for two minutes to form a protective film of CoWP alloy on the surfaces of the interconnects, followed by cleaning with pure water and drying.

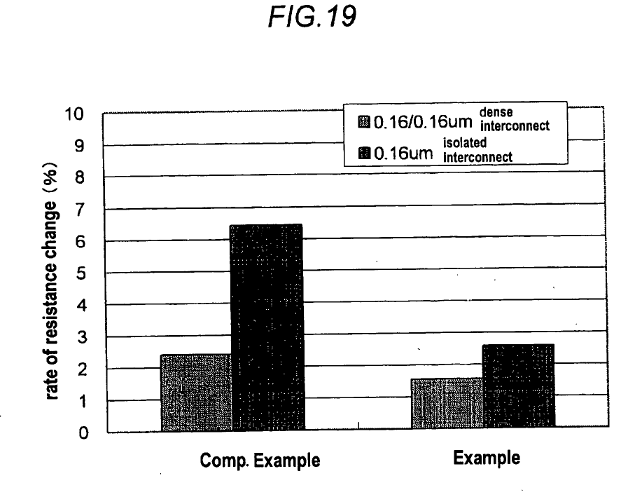

In order to determine an electric property of the interconnects of the respective samples, an electric current on application of a constant voltage was measured for each sample, before and after the series of processings, by touching needles to the pads at the ends of the interconnects, and the resistance of the interconnects was calculated. The results are shown in FIG. 19. FIG. 19 shows percentage changes in the resistances of the dense interconnects and the isolated interconnect, both having an interconnect width of 0.16 μm, for each of the samples of Example and Comp. Example. As can be seen from the data in FIG. 19, the percentage resistant change is smaller in the sample of Example for both of the dense interconnects and the isolated interconnect, particularly for the isolated interconnect, as compared to the sample of Comp. Example. The comparative data clearly indicates less pattern-dependency of the percentage resistance changes of the isolated and dense interconnects in the sample of Example.

Although certain preferred embodiments of the present invention have been described, it should be understood that the present invention is not limited to the above embodiments, and that various changes and modifications may be made therein without departing from the scope of the technical concept.

### INDUSTRIAL APPLICABILITY

An electrolytic processing method and an electrolytic processing apparatus of the present invention are useful for forming, by electroless plating, a protective film, such as a magnetic film, which covers exposed surfaces of embedded interconnects composed of an interconnect material, such as copper or silver, embedded in fine interconnect recesses provided in a surface of a substrate, such as a semiconductor wafer.

1. A substrate processing method comprising:
bringing a surface of a substrate into contact with a processing solution whose temperature is adjusted to not more than 15° C., thereby activating the surface; and
bringing the activated surface of the substrate into contact with a plating solution, thereby forming a metal film on the surface.

2. The substrate processing method according to claim 1, wherein the surface of the substrate is brought into contact with the processing solution while cooling the substrate to not more than 15° C.

3. The substrate processing method according to claim 1, wherein the substrate has embedded interconnects composed of an interconnect metal embedded in interconnect recesses, and surfaces of the embedded interconnects are activated and the metal film is formed selectively on the activated surfaces.

4. The substrate processing method according to claim 1, wherein the substrate has interconnect recesses for filling them with an interconnect metal to form embedded interconnects, and the surfaces of the interconnect recesses are activated and the metal film is formed on the activated surfaces.

5. The substrate processing method according to claim 1, wherein the processing solution is a catalytic processing solution containing a catalyst metal salt in an amount of 0.005 g/L to 10 g/L.

6. The substrate processing method according to claim 1, wherein the catalyst metal of the catalyst metal salt is at least one of Pd, Pt, Ru, Co, Ni, Au and Ag.

7. The substrate processing method according to claim 1, wherein the pH of the processing solution is 0 to 6, and is adjusted within the range of −0.2 to +0.2 around a target value.

8. The substrate processing method according to claim 1, wherein the surface of the substrate is kept in contact with the processing solution for not less than 15 seconds to activate the surface.

9. The substrate processing method according to claim 1, wherein an amount of dissolved oxygen in the processing solution is not more than 3 ppm.

10. A processing solution for contact with a surface of a substrate to activate the surface, comprising a catalyst metal salt and a pH regulator, the temperature of the solution being adjusted to not more than 15° C.

11. The processing solution according to claim 10, wherein the catalyst metal of the catalyst metal salt is at least one of Pd, Pt, Ru, Co, Ni, Au and Ag.

12. The processing solution according to claim 10, wherein the pH regulator is an acid selected from hydrochloric acid, sulfuric acid, nitric acid, citric acid, oxalic acid, formic acid, acetic acid, maleic acid, malic acid, adipic acid, pimelic acid, glutaric acid, succinic acid, fumaric acid and phthalic acid, or a base selected from aqueous ammonium solution, KOH, tetramethylammonium hydride and tetraethylammonium hydride.

13. The processing solution according to claim 10, wherein an amount of dissolved oxygen in the processing solution is not more than 3 ppm.

14. A substrate processing apparatus comprising:
a pre-processing unit for bringing a processing solution whose temperature is adjusted to not more than 15° C. into contact with a surface of a substrate, thereby activating the surface;
an electroless plating unit for carrying out plating of the activated surface of the substrate to form a metal film; and
a unit for cleaning and drying the substrate after the plating.

15. The substrate processing apparatus according to claim 14, wherein the pre-processing unit includes a substrate holder, capable of being cooled to a temperature of not more than 10° C., for holding and cooling the substrate.
